(19) United States
(12) Patent Application Publication
(10) Pub. No.: US 2020/0087105 A1
(43) Pub. Date: Mar. 19, 2020

(54) SYSTEM AND METHOD FOR EFFECTING TRANSPORTATION BY PROVIDING PASSENGER HANDOFF BETWEEN A PLURALITY OF ELEVATORS

(71) Applicant: Otis Elevator Company, Farmington, CT (US)

(72) Inventors: Rajinikanth Pusala, Hyderabad (IN); BVSP Ravichand Gangisetti, Tenali (IN)

(21) Appl. No.: 16/558,755

(22) Filed: Sep. 3, 2019

(30) Foreign Application Priority Data
Sep. 14, 2018 (IN) 201811034757

(51) Int. Cl. B66B 1/28; B66B 1/46; B66B 1/34; B66B 5/00

(52) U.S. Cl. CPC B66B 1/28; B66B 1/468; B66B 1/3461; B66B 2201/4615; B66B 2201/4653; B66B 2201/103; B66B 5/0012

(57) ABSTRACT

Disclosed is an elevator system having a plurality of elevators including a first elevator and a second elevator, the plurality of elevators servicing a respective plurality of sets of floors, wherein the first elevator services a first set of the plurality of sets of floors and the second elevator services a second set of the plurality of sets of floors, wherein the first set of floors includes a first floor and a common floor and the second set of floors includes a second floor and the common floor, and the system receives a request from the first device to travel from the first floor to the second floor, executes a first transportation directive to effect transportation by providing handoff between the plurality of elevators, which includes: instructing the first elevator to provide service to the first floor, and instructing the second elevator to provide service to the common floor.

### CROSS-REFERENCE TO RELATED APPLICATIONS

This application claims the benefit of IN Patent Application no. 201811034757 filed Sep. 14, 2018, the disclosure of which is incorporated herein by reference in its entirety.

### BACKGROUND

The embodiments herein relate to elevator systems and more specifically to a system and method for effecting transportation requiring handoff between a plurality of elevators.

Elevators in high rise buildings may be divided into multiple groups for effective traffic management and to reduce travel time. Not all elevator groups may serve from a bottom floor to a top floor of the building. Users may remotely register destination requests to selected elevator groups. If source floors and destination floors do not belong to same elevator group, a user may have to provide multiple destination calls in an effort to reach a destination.

### SUMMARY

Disclosed is an elevator system in a building, the elevator system comprising a plurality of elevators including a first elevator and a second elevator, the plurality of elevators servicing a respective plurality of sets of floors, wherein the first elevator services a first set of the plurality of sets of floors and the second elevator services a second set of the plurality of sets of floors, wherein the first set of floors includes a first floor and a common floor and the second set of floors includes a second floor and the common floor, and a controller communicating over a network with a first device, wherein the controller: receives a request from the first device to travel from the first floor to the second floor, executes a first transportation directive to effect transportation by providing handoff between the plurality of elevators, which includes: instructing the first elevator to provide service to the first floor, and instructing the second elevator to provide service to the common floor.

In addition to one or more of the above disclosed features or as an alternate executing the first transportation directive includes the controller: determining that the first device is within the first elevator, instructing the first elevator to travel to the common floor, determining the first device is within the second elevator, and instructing the second elevator to travel to the second floor.

In addition to one or more of the above disclosed features or as an alternate executing the first transportation directive includes the controller: determining that the first elevator is approaching the common floor before instructing the second elevator to travel to the common floor.

In addition to one or more of the above disclosed features or as an alternate executing the first transportation directive includes maintaining the second elevator on the common floor for a first period of time that accounts for delays in transportation of the first elevator between the first floor and the common floor.

In addition to one or more of the above disclosed features or as an alternate the first period of time includes time in which the device is expected to travel between the plurality of elevators on the common floor.

In addition to one or more of the above disclosed features or as an alternate executing the first transportation directive includes monitoring one or both of position and direction of travel of the device on the common floor.

In addition to one or more of the above disclosed features or as an alternate monitoring the device on the common floor includes receiving GPS data from the device.

In addition to one or more of the above disclosed features or as an alternate executing the first transportation directive includes the controller terminating the first transportation directive upon determining that service pursuant to the first service request will fail to be received by the device.

In addition to one or more of the above disclosed features or as an alternate the device includes a display screen, and wherein executing the first transportation directive includes transmitting to the device first data for displaying on the screen, the first data including information for the first transportation directive including an indicator of the second elevator being positioned on the common floor to provide transportation between the common floor and the second floor.

In addition to one or more of the above disclosed features or as an alternate executing the first transportation directive includes transmitting to the device second data for displaying on the screen, the second data indicating that the first transportation directive is terminated upon determining that service pursuant to the first service request will fail to be received by the device.

Further disclosed is a method of effecting transportation by providing handoff between a plurality of elevators in an elevator system, the elevator system being in a building, the elevator system comprising one or more of the above disclosed features, and the method comprises the controller receiving a request from the first device to travel from the first floor to the second floor, executing a first transportation directive for the plurality of elevators, which includes: instructing the first elevator to provide service to the first floor, and instructing the second elevator to provide service to the common floor.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 illustrates additional features of the disclosed embodiments; and

FIG. 3 illustrates a process according to one or more disclosed embodiments.

### DETAILED DESCRIPTION

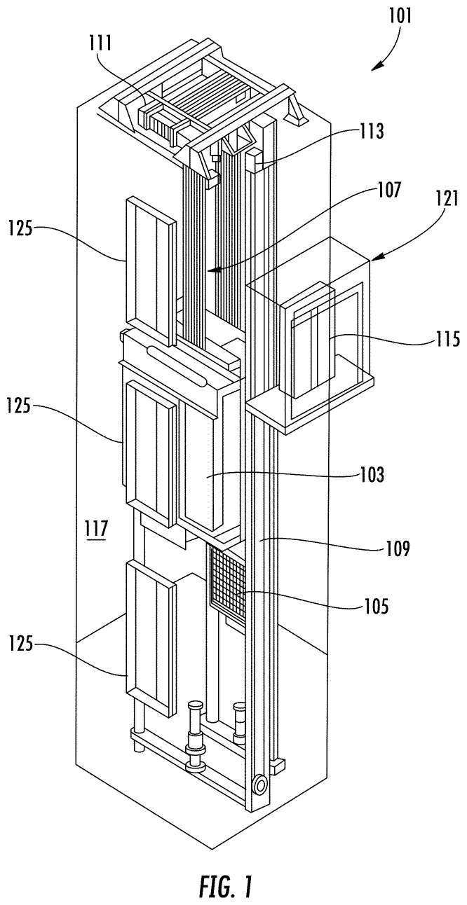

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator hoistway 117, such as on a support or guide rail, and may be configured to provide position signals related to a position of the elevator car 103 within the elevator hoistway 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator hoistway 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator hoistway 117.

Although shown and described with a roping system including tension member 107, elevator systems that employ other methods and mechanisms of moving an elevator car within an elevator hoistway may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

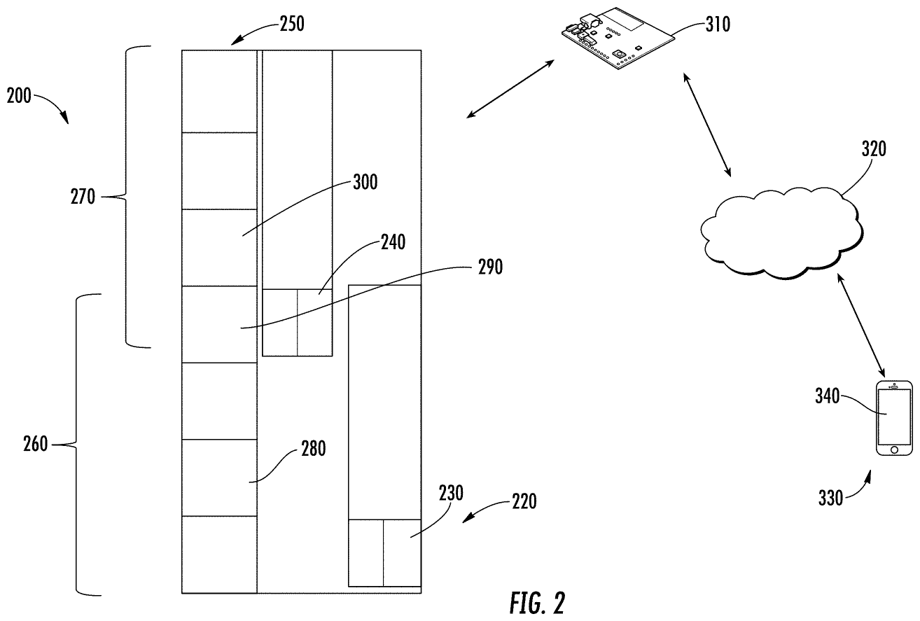

Disclosed in FIG. 2 is an elevator system generally referred to as 200. The elevator system 200 is disposed in a building 210. The elevator system 200 may include a plurality of elevators generally referred to as 220, including a first elevator 230 and a second elevator 240. The plurality of elevators 220 may service a respective plurality of sets of floors generally referred to as 250. The first elevator 230 may services a first set 260 of the plurality of sets of floors 250 and the second elevator 240 may service a second set 270 of the plurality of sets of floors 250. The first set of floors 260 may include a first floor 280 and a common floor 290. The second set of floors 270 may include a second floor 300 and the common floor 290. The first elevator 230 and the second elevator 240 may be connected on the common floor 290. The system 200 may include a controller 310 communicating over a network 320 with a first device 330, which may be a mobile phone used by a person seeking to request elevator service.

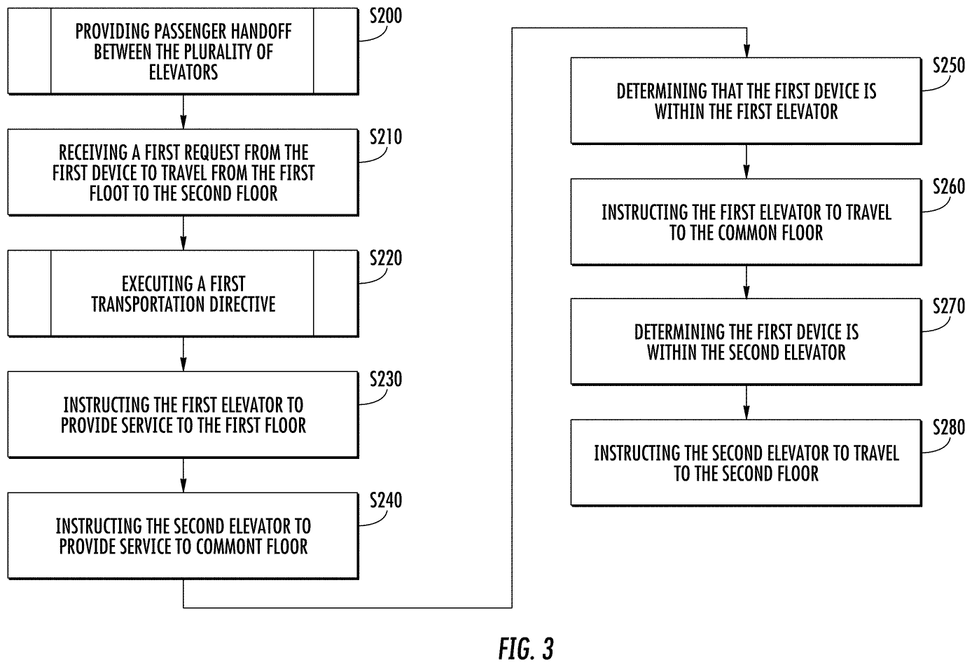

As disclosed in FIG. 3, the controller 310 may perform a process S200 of effecting transportation by providing passenger handoff between the plurality of elevators 250. Under process S200, the controller 310 may perform step S210 of receiving a first request from the first device 330 to travel from the first floor 280 to the second floor 300. The controller 310 may then perform step S220 of executing a first transportation directive to the plurality of elevators 220. Step S220 may include step S230 of instructing the first elevator 230 to provide service to the first floor 280, and step S240 of instructing the second elevator to provide service to common floor 290.

According to a disclosed embodiment, step S220 may include the controller 310 performing step S250 of determining that the first device 330 is within the first elevator 230. This would be indicative of the passenger being in the first elevator. Then step S220 may include step S260 of instructing the first elevator 230 to travel to the common floor 290. That is, the first elevator 230 transports the passenger to the common floor 300 in order for the passenger to travel on common floor 290 to the second elevator 240. Step S220 may include step S270 of the controller 310 determining the first device 330 is within the second elevator 240. This may be indicative of the passenger entering the second elevator 240 for travel to the second floor 300. Step S220 may further include step S280 of the controller 310 instructing the second elevator 240 to travel to the second floor 300. This would deliver the passenger to the second floor 300.

According to a further aspect of the disclosed embodiments step S220 may include the controller 310 determining that the first elevator 230 is approaching the common floor 290 before instructing the second elevator 240 to travel to the common floor 290. Thus, if the first elevator 230 travels many floors and/or if a delay occurs during travel of the first elevator 230, the impact on the second elevator 240 is minimized.

According to a further aspect of the disclosed embodiments step S220 may include maintaining the second elevator 240 on the common floor for a first period of time. The first period of time may accounts for delays in transportation of the first elevator 230. According to a further aspect of the disclosed embodiments the first period of time may include time in which the device 330 is expected to travel between plurality of elevators 220 on the common floor 290. That is, upon reaching the common floor 290, the device 330, carried by the passenger, may be transported on the common floor 290 between the elevators 220, for example by walking. It is within the scope of the disclosure to have elevators 250 separated by significant distances on a common lobby so that the period of time to maintain the second elevator 240 on the common floor 290 may, under certain situations, be considerable. In addition, according to an embodiment, the controller 310 may register a type of passenger associated with the device 330 which may necessitate adjusting allotted time for traveling between elevators. For example, the passenger may use a motion assisting implement such as a wheelchair, or the passenger may be accompanied by an entourage for various reasons.

According to an embodiment step S220 may include monitoring one or both of position and direction of travel of the device 330 on the common floor 290. For example the passenger may pause on the common floor 290 and/or decide to not continue to the second elevator 240 for a variety for reasons. Monitoring the device 330 on the common floor 290 may include receiving GPS data from the device 330. With GPS data, for example, a dead reckoning analysis may be performed in which the controller 310 may determine the direction being traveled by the device 330 and therefore the passenger.

According to an embodiment step S220 may include the controller 310 terminating the first transportation directive upon determining that service pursuant to the first service request will fail to be received by the device 330. That is, based on location and trajectory data for the passenger having the device 330, the controller 310 may render a determination that the passenger has abandoned the first request.

According to an embodiment the device 330 may include a display screen 340 (FIG. 2). As such, executing the first transportation directive may include the controller 310 transmitting to the device 330 data for displaying on the screen 340. The data may include information relevant to the first transportation directive. Such information may include an indicator of the second elevator 240 being positioned on the common floor 290 to provide transportation between the common floor 290 and the second floor 300. The data may further include a notification that the first transportation directive is being terminated, for example, based on a location and direction of travel after the device exits the first elevator 230, as indicated above.

According to the disclosed embodiments a single destination request may facilitate travelling between elevator groups by executing the above algorithms. Calls to destinations may be split into multiple elevator instructions. When a passenger identifies a destination request of choice, a controller may verify whether the request may be served by single group if so the call is registered accordingly and a single journey may be split into multiple phases. In a first phase, an elevator of a first group may be allocated to take passengers to a nearest intermediate destination. As the elevator advances to the first intermediate destination, the controller may auto register a second destination request to a respective second elevator group for a second phase of travel and inform the user by displaying information on the mobile screen about the next assigned elevator.

The disclosed embodiments may enable a user to avoid a circumstance in which the user is otherwise may be required to make multiple elevator calls at multiple destinations. The disclosed embodiments may reduce wait time and travel time and provide relatively seamless access of various elevator groups.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system in a building, the elevator system comprising
a plurality of elevators including a first elevator and a second elevator,
the plurality of elevators servicing a respective plurality of sets of floors, wherein the first elevator services a first set of the plurality of sets of floors and the second elevator services a second set of the plurality of sets of floors, wherein the first set of floors includes a first floor and a common floor and the second set of floors includes a second floor and the common floor, and
a controller communicating over a network with a first device, wherein the controller:
receives a request from the first device to travel from the first floor to the second floor,
executes a first transportation directive to effect transportation by providing handoff between the plurality of elevators, which includes:
instructing the first elevator to provide service to the first floor, and
instructing the second elevator to provide service to the common floor.

2. The system of claim 1 wherein executing the first transportation directive includes the controller:
determining that the first device is within the first elevator,
instructing the first elevator to travel to the common floor,
determining the first device is within the second elevator, and
instructing the second elevator to travel to the second floor.

3. The system of claim 2 wherein executing the first transportation directive includes the controller:
determining that the first elevator is approaching the common floor before instructing the second elevator to travel to the common floor.

4. The system of claim 3 wherein executing the first transportation directive includes maintaining the second elevator on the common floor for a first period of time that accounts for delays in transportation of the first elevator between the first floor and the common floor.

5. The system of claim 4 wherein the first period of time includes time in which the device is expected to travel between the plurality of elevators on the common floor.

6. The system of claim 5 wherein executing the first transportation directive includes monitoring one or both of position and direction of travel of the device on the common floor.

7. The system of claim 6 wherein monitoring the device on the common floor includes receiving GPS data from the device.

8. The system of claim 7 wherein executing the first transportation directive includes the controller terminating the first transportation directive upon determining that service pursuant to the first service request will fail to be received by the device.

9. The system of claim 8 wherein the device includes a display screen, and
wherein executing the first transportation directive includes transmitting to the device first data for displaying on the screen, the first data including information for the first transportation directive including an indicator of the second elevator being positioned on the common floor to provide transportation between the common floor and the second floor.

10. The system of claim 9 wherein executing the first transportation directive includes transmitting to the device second data for displaying on the screen, the second data indicating that the first transportation directive is terminated upon determining that service pursuant to the first service request will fail to be received by the device.

11. A method of effecting transportation by providing handoff between a plurality of elevators in an elevator system, the elevator system being in a building, and the elevator system comprising
a plurality of elevators including a first elevator and a second elevator,
the plurality of elevators servicing a respective plurality of sets of floors, wherein the first elevator services a first set of the plurality of sets of floors and the second elevator services a second set of the plurality of sets of floors, wherein the first set of floors includes a first floor and a common floor and the second set of floors includes a second floor and the common floor, and
a controller communicating over a network with a first device,
wherein the method comprises the controller:
receiving a request from the first device to travel from the first floor to the second floor,
executing a first transportation directive for the plurality of elevators, which includes:
instructing the first elevator to provide service to the first floor, and
instructing the second elevator to provide service to the common floor.

12. The method of claim 11 wherein executing the first transportation directive includes the controller:
determining that the first device is within the first elevator,
instructing the first elevator to travel to the common floor,
determining the first device is within the second elevator, and
instructing the second elevator to travel to the second floor.

13. The method of claim 12 wherein executing the first transportation directive includes the controller:
determining that the first elevator is approaching the common floor before instructing the second elevator to travel to the common floor.

14. The method of claim 13 wherein executing the first transportation directive includes maintaining the second elevator on the common floor for a first period of time that accounts for delays in transportation of the first elevator between the first floor and the common floor.

15. The method of claim 14 wherein the first period of time includes time in which the device is expected to travel between the plurality of elevators on the common floor.

16. The method of claim 15 wherein executing the first transportation directive includes monitoring one or both of position and direction of travel of the device on the common floor.

17. The method of claim 16 wherein monitoring the device on the common floor includes receiving GPS data from the device.

18. The system of claim 17 wherein executing the first transportation directive includes the controller terminating the first transportation directive upon determining that service pursuant to the first service request will fail to be received by the device.

19. The method of claim 18 wherein the device includes a display screen and,
wherein executing the first transportation directive includes transmitting to the device first data for displaying on the screen, the first data including information for the first transportation directive including an indicator of the second elevator being positioned on the common floor to provide transportation between the common floor and the second floor.

20. The method of claim 19 wherein executing the first transportation directive includes transmitting to the device second data for displaying on the screen, the second data indicating that the first transportation directive is terminated upon determining that service pursuant to the first service request will fail to be received by the device.
